(19) United States
(12) Patent Application Publication
(10) Pub. No.: US 2026/0158687 A1
(43) Pub. Date: Jun. 11, 2026

(54) COUPLING AND DECOUPLING A MAIN HOUSING AND A FUNCTIONAL ATTACHMENT OF A HANDHELD PERSONAL CARE DEVICE

(71) Applicant: KONINKLIJKE PHILIPS N.V., EINDHOVEN (NL)

(72) Inventors: Michael Reece JENKINS, AMSTERDAM (NL); Gernot Walter KÜNZEL, EINDHOVEN (NL); Hendrik Jouke BIJL, EINDHOVEN (NL)

(21) Appl. No.: 18/707,637

(22) PCT Filed: Nov. 3, 2022
(86) PCT No.: PCT/EP2022/080633

§ 371 Date: May 6, 2024

(30) Foreign Application Priority Data
Nov. 9, 2021 (EP) 21207286.2

(51) Int. Cl. B26B 19/38

(52) U.S. Cl. CPC B26B 19/386; B26B 19/3813

(57) ABSTRACT

In a handheld personal care device (1), a main housing (10) comprises a first coupling member (23), and a functional attachment (30) comprises a second coupling member (33). The main housing (10) further comprises a U-shaped holder (20) for receiving and accommodating a base member (31) of the functional attachment (30). The device (1) is designed to accomplish that in a coupled condition of the main housing (10) and the functional attachment (30), the main housing (10) and the functional attachment (30) are mutually retained in an axial direction (A) exclusively by mutual engagement of the first and second coupling members (23, 33), and the base member (31) is enclosed and supported by two protruding wall portions (21, 22) of the U-shaped holder (20) in a sideward direction (S) without being connected or coupled to said wall portions (21, 22) in the axial direction (A).

### FIELD OF THE INVENTION

The invention relates to a handheld personal care device comprising a main housing and a functional attachment couplable to and decouplable from the main housing, wherein the main housing comprises: a front wall, a back wall, an upper wall and two oppositely arranged side walls that interconnect the front wall and the back wall; a first coupling member arranged in said upper wall and having a first coupling axis; and a U-shaped holder formed by said upper wall and by two oppositely arranged protruding wall portions that each form an extension of a respective one of said two side walls and extend beyond said upper wall; wherein the functional attachment comprises: a base member; a functional personal care unit arranged on the base member; and a second coupling member arranged in the base member and having a second coupling axis; and wherein: the first and second coupling members are mutually couplable by aligning the first and second coupling axes and moving the first and second coupling members towards each other along the aligned first and second coupling axes into mutual engagement.

### BACKGROUND OF THE INVENTION

Handheld personal care devices comprising a main housing and a functional attachment couplable to and decouplable from the main housing are generally known, wherein it is common for the functional attachment to comprise a base member and a functional personal care unit arranged on the base member. In this respect, it is noted that more than one type of functional attachment may be used with a single main housing so that versatile use of the handheld personal care device is enabled. Further, it is noted that practical options in respect of the functional personal care unit include a shaving unit, a hair clipping unit, a beard trimming unit and a facial brushing unit.

WO 2008/062339 A1 discloses a shaving device comprising a base structure and a head structure that serves to retain and support at least one shaving head, wherein the head structure is releasably retainable on the base structure and comprises a coupling element in the form of a shaft-like element that is arranged to protrude from the head structure and comprises at its distal end a sloped surface. The base structure is free of support elements in an area of an outer circumference of the head structure such that when the head structure is coupled to the base structure, the head structure is not supported in the area of its outer circumference but is substantially only retained on the base structure by a retaining force provided by a retaining structure of the base structure. The retaining structure comprises a retaining recess for receiving the coupling element of the head structure, and also a spring element at least partly provided in the retaining recess, wherein the spring element is arranged for engaging the sloped surface of the coupling element such that the coupling element is retainable in the retaining recess.

The design of the shaving device known from WO 2008/062339 A1 has been developed against the background of protecting the head structure and the shaving head against damage in case of an overloading force. The fact is that when an external load is exerted on the head structure, the load is transferred to the coupling element. Since in the coupled state the head structure is not supported in the area of its outer circumference, the area of the outer circumference cannot contribute to transfer of the external load to the base structure. As a result, it is the coupling element that has to transfer a substantial part of the external load. When the external load gets too high, the spring element in the retaining recess of the base structure is forced to shift over the sloped surface of the coupling element. Eventually, the spring element shifts off the sloped surface, at which point the coupling element is released from the retaining structure.

KR 20-0257871 Y1 discloses an example of a handheld personal care device as defined in the opening paragraph. The known handheld personal care device includes two types of functional attachment, namely a functional attachment designed to be used as a shaving head, which will hereinafter be referred to as shaving attachment, and a functional attachment designed to be used as a hair clipping head, which will hereinafter be referred to as hair clipping attachment. When a person wishes to perform one of both possible actions of shaving and hair clipping by means of the device, all that the person needs to do is to make sure that the appropriate functional attachment is properly positioned on the main housing.

In the handheld personal care device known from KR 20-0257871 Y1, the shaving attachment comprises a safety cap and elastic hooks provided at opposite sides of the safety cap.

Similarly, the hair clipping attachment comprises a carrier body of the hair clipping blades of the attachment and elastic hooks provided at opposite sides of the carrier body. Further, the main housing is provided with recesses in an inner surface of the U-shaped holder, at opposite sides of the U-shaped holder and at positions which are chosen to enable the recesses to receive the elastic hooks when a functional attachment is put in place on the main housing. Protruding knobs are arranged on the elastic hooks, which can be pressed by a person when it is intended to remove a functional attachment from the main housing. The U-shaped holder is provided with open slots to enable passage of the protruding knobs when the functional attachment is either put in place on the main housing or removed from the main housing. When the functional attachment is in place on the main housing, the functional attachment is retained on the main housing on the basis of the fact that the elastic hooks of the functional attachment are accommodated in the recesses of the U-shaped holder of the main housing and remain in that position as long as the protruding knobs are not operated to move the elastic hooks out of the recesses. Further, when the functional attachment is in place on the main housing, the respective coupling members of the functional attachment and the main housing engage each other. In particular, the second coupling member comprises a partition wall, and the first coupling member is designed to receive the partition wall in a sandwiching fashion.

It is an object of the invention to provide another way of coupling the functional attachment to the main housing and decoupling the functional attachment from the main housing than the ways known in the art, and to thereby achieve a high level of ease of use without compromising important factors such as functionality of the functional attachment and coupling robustness.

### SUMMARY OF THE INVENTION

The invention provides a handheld personal care device comprising a main housing and a functional attachment couplable to and decouplable from the main housing, wherein the main housing comprises:
a front wall, a back wall, an upper wall and two oppositely arranged side walls that interconnect the front wall and the back wall;
a first coupling member arranged in said upper wall and having a first coupling axis; and
a U-shaped holder formed by said upper wall and by two oppositely arranged protruding wall portions that each form an extension of a respective one of said two side walls and extend beyond said upper wall;
   wherein the functional attachment comprises
a base member;
a functional personal care unit arranged on the base member; and
a second coupling member arranged in the base member and having a second coupling axis;
   and wherein:
the first and second coupling members are mutually couplable by aligning the first and second coupling axes and moving the first and second coupling members towards each other along the aligned first and second coupling axes into mutual engagement;
the first and second coupling members are mutually decouplable by exerting a decoupling force greater than a predefined threshold force on one of the first and second coupling members in an axial direction parallel to the aligned first and second coupling axes and away from the other one of the first and second coupling members;
   and wherein, in a coupled condition of the main housing and the functional attachment involving the base member being arranged within the U-shaped holder and the first and second coupling members being in mutual engagement:
the main housing and the functional attachment are mutually retained in the axial direction exclusively by the mutual engagement of the first and second coupling members; and
the base member of the functional attachment is enclosed and supported by the two protruding wall portions of the U-shaped holder in a sideward direction transverse to the aligned first and second coupling axes without being connected or coupled to said two protruding wall portions in the axial direction.

On the basis of the configuration of the handheld personal care device defined in the foregoing, it is achieved that coupling and decoupling of the main housing and the functional attachment of the device can easily be realized by a person. In fact, all that the person needs to do in order to realize coupling of the functional attachment to the main housing is to realize movement of the functional attachment and the main housing towards each other in such a way that the coupling axes of the first and second coupling members are aligned, and to continue doing so until mutual engagement of the first and second coupling members is achieved. Further, all that the person needs to do to realize decoupling of the functional attachment from the main housing is to exert a decoupling force greater than a predefined threshold force on one of the first and second coupling members in an axial direction parallel to the aligned first and second coupling axes and away from the other one of the first and second coupling members. In short, all that is needed to realize coupling of the functional attachment to the main housing is putting the functional attachment and the main housing together in the appropriate direction as determined by the design of the first and second coupling members, and all that is needed to realize decoupling of the functional attachment from the main housing is pulling the functional attachment and the main housing apart in the appropriate direction.

In the handheld personal care device according to the invention, coupling robustness is mainly obtained on the basis of the following factor: the main housing and the functional attachment are mutually retained in the axial direction by the mutual engagement of the first and second coupling members, wherein the mutual engagement as mentioned is only broken when a decoupling force greater than a predefined threshold force is exerted on one of the coupling members in a specific direction. Further, sideward movement of the functional attachment is prevented by means of the two protruding wall portions of the U-shaped holder.

The invention covers various possibilities in respect of the way in which mutual engagement of the first and second coupling members can be realized. For example, use may be made of a combination of magnets, or a combination of a spring element and a coupling element having a sloped surface, wherein the spring element can engage on the sloped surface, as known from WO 2008/062339 A1.

Coupling robustness can be further enhanced when the handheld personal care device according to the invention is designed such that in the coupled condition of the main housing and the functional attachment, the base member of the functional attachment is supported by the upper wall of the main housing. For example, it may be so that the design of the device involves the following aspects: the base member comprises a bottom wall; the second coupling member is arranged in said bottom wall; and in the coupled condition of the main housing and the functional attachment, said bottom wall is at least partially supported by the upper wall of the main housing. This design offers a very practical way of avoiding incorrect positioning of the functional attachment on the main housing by a person. The fact is that it is possible to provide the coupling with an inclined character, wherein the upper wall of the main housing has an inclined orientation relative to an imaginary plane extending perpendicularly to the first coupling axis, and the bottom wall of the base member has an inclined orientation relative to an imaginary plane extending perpendicularly to the second coupling axis. In such a case, any person can immediately see which way of putting the functional attachment and the main housing is the correct one, as it is very easy to find how two inclined walls can be aligned.

Preferably, in order to have a smooth overall appearance of the handheld personal care device according to the invention in the coupled condition of the main housing and the functional attachment, the base member of the functional attachment comprises a front wall and a back wall which are designed such that in the coupled condition of the main housing and the functional attachment, the front wall and the back wall of the base member are flush with, respectively, the front wall and the back wall of the main housing.

A further option in respect of the base member is that the base member comprises a front wall, a back wall and two oppositely arranged side walls that interconnect the front wall and the back wall of the base member, wherein, in the coupled condition of the main housing and the functional attachment, the side walls of the base member are each at least partially supported by a respective one of the two protruding wall portions of the U-shaped holder in the sideward direction.

In order to achieve stable support against rotations of the functional attachment about an axis extending in a front-to-back direction, i.e. in a direction perpendicular to both the axial direction and the sideward direction, it is advantageous if an average length of the two protruding wall portions of the U-shaped holder in the axial direction is at least 50%, and preferably at least 100% of an average distance between the two protruding wall portions in the sideward direction. Alternatively, it is possible that the average length of the two protruding wall portions of the U-shaped holder in the axial direction is chosen in relation to a total length of the main housing in the axial direction. In that case, it is advantageous if the average length of the two protruding wall portions of the U-shaped holder in the axial direction is between 10% and 50% of a total length of the main housing in the axial direction. As a result of the relatively large depth of the U-shaped holder, the coupling of the functional attachment to the main housing is very robust and stable.

Further, in order to achieve stable support against rotations of the functional attachment about an axis extending in the sideward direction, it is advantageous if an average distance between the front wall and the back wall of the main housing, measured along the upper wall of the main housing in the front-to-back direction is larger than an average distance between the two protruding wall portions of the U-shaped holder in the sideward direction. In that case, any rotation motion about the axis as mentioned is blocked by the material presence of the upper wall of the main housing. Another or additional way in enhancing resistance against rotations of the functional attachment about an axis extending in the sideward direction involves having a design of the main housing in which, seen in a cross-section perpendicular to the first coupling axis, an inner surface of each of the two protruding wall portions of the U-shaped holder is concave.

In practical cases, it may be so that the U-shaped holder of the main housing and the base member of the functional attachment are designed to enable the base member, in the coupled condition of the main housing and the functional attachment, to fit into the U-shaped holder only in a single predefined orientation relative to the U-shaped holder, whereby the functional attachment is couplable to the main housing only in a single predefined orientation relative to the main housing. This assists a person acting to couple the functional attachment to the main housing in actually achieving the correct and intended positioning of the functional attachment relative to the main housing. In this respect, it may be so that an inner surface of each of the two protruding wall portions of the U-shaped holder has a shape that is non-symmetrical relative to a first imaginary plane comprising the first coupling axis and extending centrally between the front wall and the back wall of the main housing, and/or non-symmetrical relative to a second imaginary plane comprising the first coupling axis and extending centrally between the two protruding wall portions of the U-shaped holder. Any person can be expected to immediately recognize non-symmetrical aspects and to see how those aspects require a particular way of putting the functional attachment and the main housing together.

According to an advantageous option, the handheld personal care device according to the invention is provided with means designed to assist a person in aligning the first and second coupling axes. For example, an embodiment of the device is feasible in which the base member and at least one of the two protruding wall portions of the U-shaped holder are provided with mutually engageable guiding members arranged parallel to the axial direction and configured and arranged to mutually engage during aligning of the first and second coupling axes and moving of the first and second coupling members towards each other along the aligned first and second coupling axes into mutual engagement. Mutual engagement of such guiding members also has a function in preventing rotation of the base member in a direction about the aligned first and second coupling axes.

The invention covers embodiments of the functional attachment including a member that is to be driven during use in order to be capable of performing an intended function. In view thereof, it may be practical if the main housing accommodates an electric motor and a driving member arranged to be driven by the motor; the base member of the functional attachment accommodates a driven member that is coupled to the driving member in the coupled condition of the main housing and the functional attachment; and the base member accommodates a mechanical transmission configured to convert motion of the driven member into a different motion of a movable portion of the functional personal care unit of the functional attachment. For example, the base member may accommodate a gear system for converting rotational motion of a drive unit in the main housing into reciprocating motion or rotational motion with a different speed. The base member may also comprise an electric interface for electrically coupling of the functional attachment to an electric or electronic unit in the main housing. Another practical option that is covered by the invention involves the electric motor being accommodated in the functional attachment, particularly at the position of the base member, in which case the driving member is accommodated in the functional attachment as well.

Numerous embodiments of the functional attachment are possible in the context of the invention. For example, as mentioned earlier, the functional personal care unit of the functional attachment may be a shaving unit, a hair clipping unit, a beard trimming unit or a facial brushing unit. Regardless of the functionality of the functional attachment, it may be practical if, seen in a direction parallel to the second coupling axis, the second coupling member is arranged in a central area of the functional attachment, but this is not necessary in the context of the invention.

The invention covers a practical option according to which 1) the handheld personal care device comprises a plurality of different functional attachments, each having a respective different functional personal care unit and each being alternatively couplable to the main housing; and 2) each of the plurality of different functional attachments comprises the base member, the second coupling member arranged in the base member, and the respective different functional personal care unit being arranged on top of the base member. This is an interesting option because there is no need for having separate devices for performing different operations. Instead, a single main housing can be used, wherein an appropriate one of a number of functional attachments is chosen by a person on the basis of an intended personal care action. In view of the way in which the functional attachment is couplable to and decouplable from the main housing, it is very easy for a person to place a functional attachment on the main housing and to remove it from the main housing when there is no longer a need for using it and/or when it is intended to use another functional attachment. The two opposite wall portions of the U-shaped holder support the base member in a rigid manner, so that relatively high loads can be exerted on the functional attachment without a risk of disengagement of the functional attachment from the main housing. Further, the loads on the optional drive interface and/or the optional electric interface are considerably reduced as a result of the supporting/retaining function of the wall portions, so that these interfaces can be of less robust design without increasing the risk of damages under the influence of high loads as may be exerted on the functional attachment.

The above-described and other aspects of the invention will be apparent from and elucidated with reference to the following detailed description of a handheld personal care device comprising a combination of a main housing and a number of different functional attachments.

### BRIEF DESCRIPTION OF THE DRAWINGS

The invention will now be explained in greater detail with reference to the figures, in which equal or similar parts are indicated by the same reference signs, and in which:

FIG. 1 diagrammatically shows an embodiment of a handheld personal care device according to the invention, comprising a main housing and a number of functional attachments couplable to and decouplable from the main housing;

FIG. 2 diagrammatically shows side views of the respective functional attachments positioned in a U-shaped holder of the main housing;

FIGS. 3 and 4 diagrammatically show a front view and a back view of the main housing and a functional attachment in a coupled condition;

FIGS. 5 and 6 diagrammatically show a side sectional view and a back view of the main housing and a functional attachment in a coupled condition, wherein interior components of the main housing can be seen;

FIG. 7 illustrates options in respect of a depth of the U-shaped holder of the main housing;

FIG. 8 illustrates relevant distances and imaginary planes in the main housing;

FIG. 9 diagrammatically shows a side view of a functional attachment;

FIG. 10 illustrates alignment of the main housing and the functional attachment relative to each other;

FIGS. 11 and 12 illustrate an inclined character of the coupling of the functional attachment to the main housing; and

FIGS. 13 and 14 illustrate a non-symmetric character of the coupling of the functional attachment to the main housing.

### DETAILED DESCRIPTION OF THE EMBODIMENTS

The invention relates to a handheld personal care device 1 comprising a main housing 10 and a functional attachment 30 couplable to and decouplable from the main housing 10. In the figures, an embodiment of the handheld personal care device 1 is shown in which the device 1 comprises a number of functional attachments 30 which can each be coupled to and decoupled from a single main housing 10. The device 1 is shown in a normal orientation, which is an orientation in which the functional attachment 30 is positioned on top of the main housing 10, and it is this orientation that is at the basis of terms as used in the present text for indicating positioning of components. Still, it is to be noted that the definitions of the device 1 in the attached claims is not restricted to this orientation, that is to say, the definitions are applicable to the device 1 in any possible orientation.

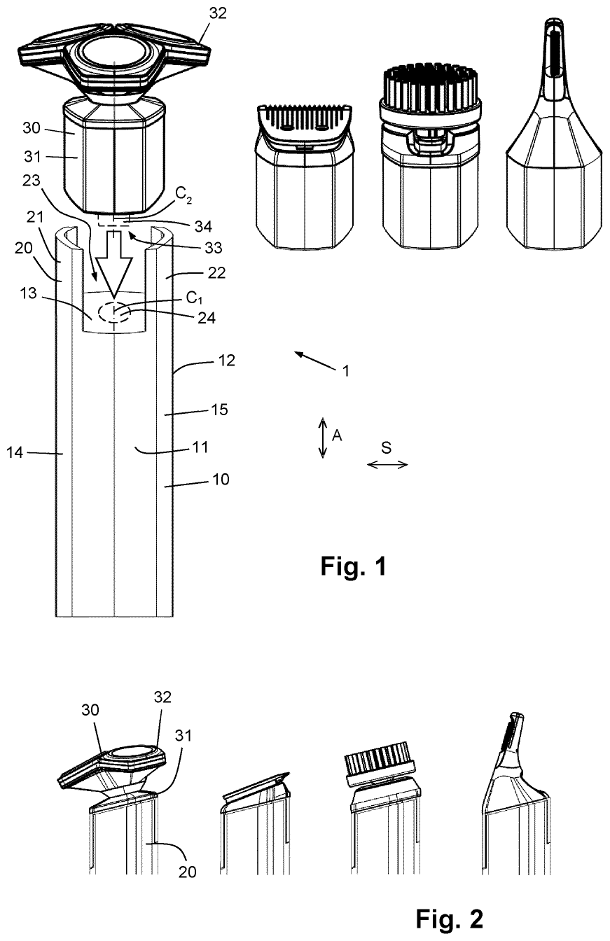

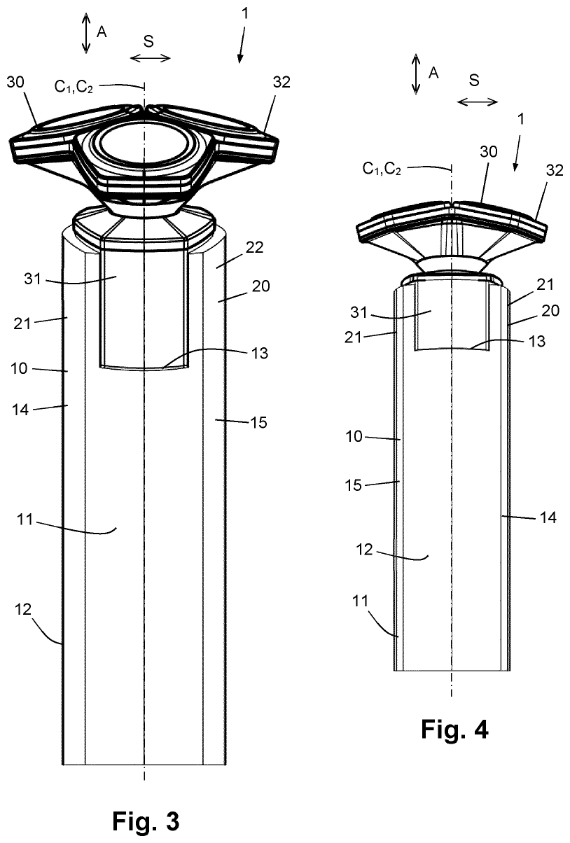

In FIG. 1, the main housing 10 and five functional attachments 30 of the handheld personal care device 1 are shown, wherein it is indicated how a functional attachment 30 can be coupled to the main housing 10 by means of a downward arrow. FIGS. 2-4 relate to a coupled condition of the main housing 10 and the functional attachment 30, wherein in FIG. 2, the respective functional attachments 30 are shown as positioned in a U-shaped holder 20 of the main housing 10, and in FIGS. 3 and 4, the entirety of the main housing 10 and a functional attachment 30 coupled to the main housing 10 is shown.

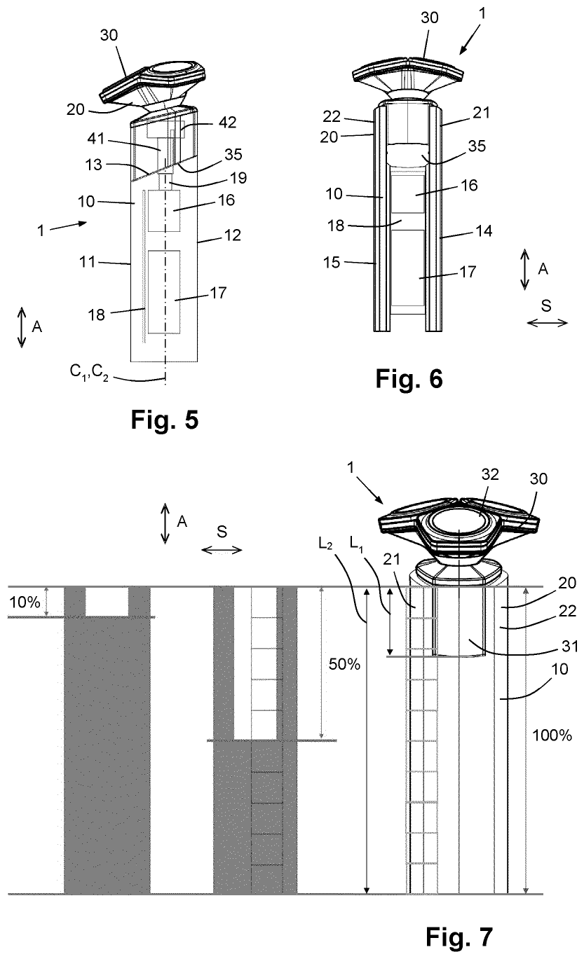

The general set-up of the main housing 10 is that the main housing 10 comprises a front wall 11, a back wall 12, an upper wall 13, a left side wall 14 and a right side wall 15. The side walls 14, 15 are oppositely arranged and interconnect the front wall 11 and the back wall 12. The above-mentioned U-shaped holder 20 of the main housing 10 is formed by the upper wall 13 and by two oppositely arranged protruding wall portions 21, 22 that each form an extension of a respective one of the two side walls 14, 15 and extend beyond the upper wall 13. With reference to FIGS. 5 and 6, it is noted that the main housing 10 accommodates an electric motor 16, and also a battery 17, which may be rechargeable, and a printed circuit board 18 which is functional in processing input from a person using the handheld personal care device 1 and controlling operation of the device 1 in relation to such input and on the basis of algorithms.

The main housing 10 further comprises a first coupling member 23, which is arranged in the upper wall 13 and which has a first coupling axis C₁. For example, it may be so that the first coupling member 23 comprises an aperture 24 provided in the upper wall 13, as diagrammatically indicated in FIG. 1 in dashed lining, which aperture 24 provides access from outside of the main housing 10 to the output shaft of the motor 16. In the following, it is assumed that the design of the first coupling member 23 involves such an aperture 24, indeed, which does not alter the fact that other designs of the first coupling member 23 are feasible in the context of the invention as well.

A robust coupling of the functional attachment 30 to the main housing 10 can be obtained on the basis of various possible measures, including a measure of having sufficient depth of the U-shaped holder 20. In FIG. 7, it is illustrated that it is practical if the depth as mentioned, i.e. an average length L₁ of the two protruding wall portions 21, 22 of the U-shaped holder 20 in an axial direction A parallel to the first coupling axis C₁ is chosen so as to be between 10% and 50% of a total length L₂ of the main housing 10 in the axial direction A.

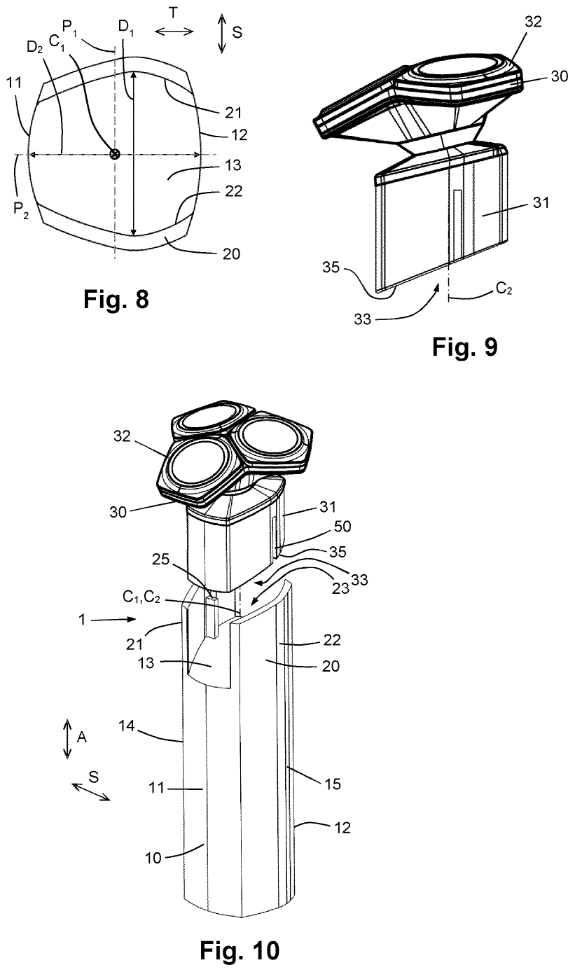

With reference to FIG. 8, in which a diagrammatic top view of the main housing 10 is shown, it is noted that two further advantageous options in respect of relative dimensions in the main housing are the following: 1) an average length L₁ of the two protruding wall portions 21, 22 of the U-shaped holder 20 in the axial direction A is at least 50%, and preferably at least 100% of an average distance D₁ between the two protruding wall portions 21, 22 in the sideward direction S, and 2) an average distance D₂ between the front wall 11 and the back wall 12 of the main housing 10, measured along the upper wall 13 of the main housing 10 in a direction T perpendicular to both the axial direction A and the sideward direction S, is larger than the average distance DI between the two protruding wall portions 21, 22 of the U-shaped holder 20 in the sideward direction S.

Further in FIG. 8, a first imaginary plane P₁ comprising the first coupling axis C₁ and extending centrally between the front wall 11 and the back wall 12 of the main housing 10 and a second imaginary plane P₂ comprising the first coupling axis C₁ and extending centrally between the two protruding wall portions 21, 22 of the U-shaped holder 20 are indicated by means of dashed lines.

The functional attachment 30 is separately shown in FIG. 9. The general set-up of the functional attachment 30 is that the functional attachment 30 comprises a base member 31 and a functional personal care unit 32 arranged on the base member 31. The functional attachments 30 shown in FIGS. 1 and 2 differ from each other as far as the design and the functionality of the functional personal care unit 32 is concerned. Seen from left to right in FIGS. 1 and 2, the following functional personal care units 32 are shown: a shaving unit, a beard trimming unit, a facial brushing unit, and a nose and ear hair trimming unit. The specific embodiments of the functional personal care unit 32 of the functional attachment 30 shown in figures are practical examples in the context of the invention, wherein it is to be noted that numerous other options in respect of the design and the functionality of the functional personal care unit 32 are covered by the invention.

It may be practical if the first coupling axis C₁ coincides with a rotation axis of an output shaft of the motor 16, and further if a driving member 19 for transmitting motion to a driven member 41 accommodated in the base member 31 is coupled to or integrated with the output shaft, wherein further a mechanical transmission 42 may be applied between the driven member 41 and a movable portion of the functional personal care unit 32 to convert motion of the driven member 41 into a different motion of the movable portion of the functional personal care unit 32, as illustrated in FIG. 5.

The functional attachment 30 further comprises a second coupling member 33, which is arranged in or on the base member 31 and which has a second coupling axis C₂. For example, it may be so that the second coupling member 33 comprises a projection 34 extending from a bottom wall 35 of the base member 31, as diagrammatically indicated in FIG. 1 in dashed lining, particularly a projection 34 configured to be received in the aperture 24 provided in the upper wall 13 of the main housing 10 when the functional attachment 30 is coupled to the main housing 10. In the following, it is assumed that the design of the second coupling member 33 involves such a projection 34, indeed, which does not alter the fact that other designs of the second coupling member 33 are feasible in the context of the invention as well.

The first coupling member 23 and the second coupling member 33 further comprise components which are especially designed to releasably engage on each other by moving the first and second coupling members 23, 33 towards each other along the aligned first and second coupling axes C₁, C₂, and to decouple from each other by exerting a decoupling force greater than a predefined threshold force on one of the first and second coupling members 23, 33 in the axial direction A. In conformity with what is known from WO 2008/062339 A1, the first coupling member 23 may comprise a U-shaped spring element positioned in the aperture 24, and the second coupling member 33 may comprise two sloped surfaces provided in recesses at diametrically opposite positions on the projection 34, wherein the legs of the U-shaped spring element engage on the sloped surfaces in the coupled condition of the main housing 10 and the functional attachment 30, to mention one of many feasible practical examples. An alternative solution to achieve a similar coupling and decoupling functionality is the arrangement of a pair of mutually attracting magnets on the projection 34 and in the aperture 24. In any case, the projection 34 can be designed so as to allow coupling of the output shaft of the motor 16 to a driven member 41 accommodated in the base member 31 in case the functional attachment 30 is of the type comprising a mechanical system including at least one movable component, such as a mechanical transmission 42, as suggested earlier.

Features of the first coupling member 23 of the main housing 10 and the second coupling member 33 of the functional attachment 30 are the following:
the first and second coupling members 23, 33 are mutually couplable by aligning the first and second coupling axes C₁, C₂ and moving the first and second coupling members 23, 33 towards each other along the aligned first and second coupling axes C₁, C₂ into mutual engagement; and
the first and second coupling members 23, 33 are mutually decouplable by exerting a decoupling force greater than a predefined threshold force on one of the first and second coupling members 23, 33 in the axial direction A and away from the other one of the first and second coupling members 23, 33.

Alignment of the main housing 10 and the functional attachment 30 relative to each other, as appropriate when it is intended to couple the functional attachment 30 to the main housing 10, is illustrated in FIG. 10.

As follows from the above description and as can be derived from the figures, the design of the handheld personal care device 1 is such that in the coupled condition of the main housing 10 and the functional attachment 30, in which condition the base member 31 of the functional attachment 30 is arranged within the U-shaped holder 20 of the main housing 10, and in which condition the first and second coupling members 23, 33 are in mutual engagement:
the main housing 10 and the functional attachment 30 are mutually retained in the axial direction A exclusively by the mutual engagement of the first and second coupling members 23, 33; and
the base member 31 of the functional attachment 30 is enclosed and supported by the two protruding wall portions 21, 22 of the U-shaped holder 20 in a sideward direction S transverse to the aligned first and second coupling axes C₁, C₂ without being connected or coupled to said two protruding wall portions 21, 22 in the axial direction A.

Further, in the shown embodiment of the handheld personal care device 1, the base member 31 of the functional attachment 30 is supported by the upper wall 13 of the main housing 10 in the coupled condition of the main housing 10 and the functional attachment 30.

In FIG. 10, it can be seen that the base member 31 and the two protruding wall portions 21, 22 of the U-shaped holder 20 are provided with mutually engageable guiding members 25, 50 arranged parallel to the axial direction A. The guiding members 25, 50 serve to facilitate the process of coupling the functional attachment 30 to the main housing 10, particularly by realizing the alignment that is appropriate in the process, and constitute visual use cues for correct installation. Also in FIG. 10, it can be seen that an inner surface of each of the two protruding wall portions 21, 22 of the U-shaped holder 20 is slightly concavely curved. Likewise, an outer surface at opposite sides of the base member 31 of the functional attachment 30 is slightly convexly curved. As a result, rotation of the functional attachment 30 about an axis extending in the sideward direction S is prevented in the coupled condition of the main housing 10 and the functional attachment 10. Hence, this aspect contributes to coupling robustness in the handheld personal care device 1, besides other aspects already described in the foregoing.

The handheld personal care device 1 described in the foregoing and illustrated in the figures has a high level of ease of use, combined with the above-mentioned coupling robustness and an advantageous distribution of forces. Coupling a functional attachment 30 to the main housing 10 is simply done by moving the functional attachment 30 towards the main housing 10 in an orientation in which the first and second coupling axes C₁, C₂ are aligned. A person who has the functional attachment 30 and the main housing 10 in his/her hands is assisted in realizing the orientation as mentioned by means of the respective guiding members 25, 50 in the U-shaped holder 20 of the main housing 10 and on the base member 31 of the functional attachment 30 engaging each other, and also by means of the projection 34 on the base member 31 being received in the aperture 24 in the upper wall 13 of the main housing 10.

Once the coupling of the functional attachment 30 to the main housing 10 is established, the base member 31 is securely held in the U-shaped holder 20, and any movable component such as a shaft or gear and/or any electric component in the functional attachment 30 can be driven on the basis of a connection to appropriate interior components of the main housing 10 through the first and second coupling members 23, 33. Decoupling the functional attachment 30 from the main housing 10 requires no more than taking hold of the main housing 10 and the functional attachment 30 and pulling the main housing 10 and the functional attachment 30 apart with sufficient force, i.e. with a decoupling force greater than a predefined threshold force.

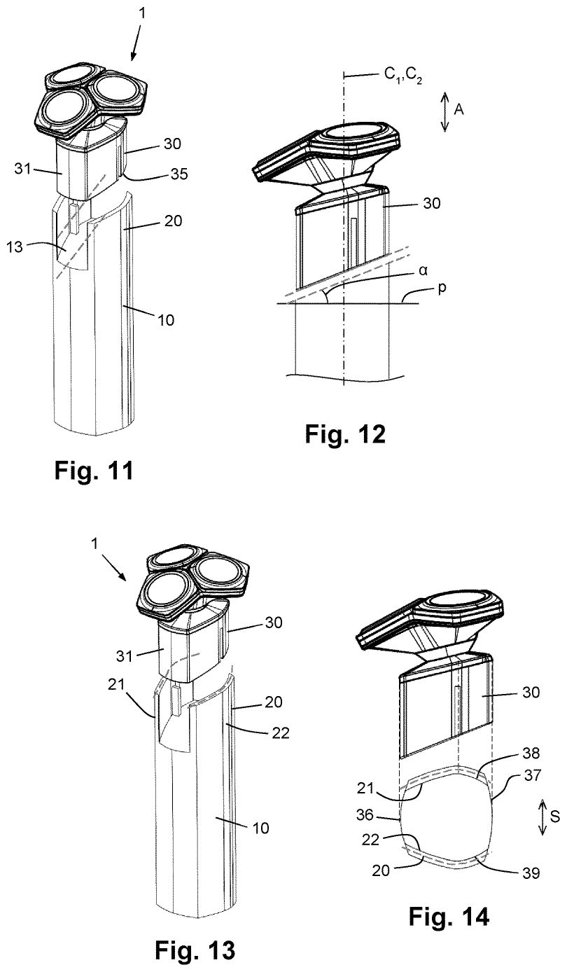

In FIGS. 11 and 12, a further aspect of the design of the handheld personal care device 1 that helps a person in placing the base member 31 of the functional attachment 30 in the U-shaped holder 20 of the main housing 10 in a correct fashion is illustrated. This aspect involves both the upper wall 13 of the main housing 10 and the bottom wall 35 of the base member 31 having an inclined orientation, at a similar angle a relative to an imaginary plane p extending perpendicularly to the axial direction A.

In FIGS. 13 and 14, another aspect of the design of the handheld personal care device 1 that helps a person in placing the base member 31 of the functional attachment 30 in the U-shaped holder 20 of the main housing 10 in a correct fashion is illustrated. This aspect involves both the inner surface of the protruding wall portions 21, 22 of the U-shaped holder 20 and the outer surface of the base member 31 having an appearance that is non-symmetrical in the general configuration of the device 1. On the basis of the non-symmetrical appearance, the base member 31 can be fitted into the U-shaped holder 20 only in a single predefined orientation relative to the U-shaped holder 20. A representation of how the base member 31 fits into the U-shaped holder 20 is provided at the bottom of FIG. 14. The design of the base member 31 with a front wall 36, a back wall 37 and two oppositely arranged side walls 38, 39 that interconnect the front wall 36 and the back wall 37 of the base member 31 can also be clearly seen in FIG. 14. It is illustrated that in the shown example, in the coupled condition of the main housing 10 and the functional attachment 30, the side walls 38, 39 of the base member 31 are each fully supported by a respective one of the two protruding wall portions 21, 22 of the U-shaped holder 20 in the sideward direction S.

It will be clear to a person skilled in the art that the scope of the invention is not limited to the examples discussed in the foregoing, and that several amendments and modifications thereof are possible without deviating from the scope of the invention as defined in the attached claims. It is intended that the invention be construed as including all such amendments and modifications insofar they come within the scope of the claims or the equivalents thereof. While the invention has been illustrated and described in detail in the figures and the description, such illustration and description are to be considered illustrative or exemplary only, and not restrictive. The invention is not limited to the disclosed embodiments. The drawings are schematic, wherein details which are not required for understanding the invention may have been omitted, and not necessarily to scale.

Variations to the disclosed embodiments can be understood and effected by a person skilled in the art in practicing the claimed invention, from a study of the figures, the description and the attached claims. In the claims, the word “comprising” does not exclude other steps or elements, and the indefinite article “a” or “an” does not exclude a plurality. Any reference signs in the claims should not be construed as limiting the scope of the invention.

Elements and aspects discussed for or in relation with a particular embodiment may be suitably combined with elements and aspects of other embodiments, unless explicitly stated otherwise. Thus, the mere fact that certain measures are recited in mutually different dependent claims does not indicate that a combination of these measures cannot be used to advantage.

The terms “comprise” and “include” as used in this text will be understood by a person skilled in the art as covering the term “consist of”. Hence, the term “comprise” or “include” may in respect of an embodiment mean “consist of”, but may in another embodiment mean “contain/have/be equipped with at least the defined species and optionally one or more other species”.

Notable aspects of the invention are summarized as follows. In a handheld personal care device 1 comprising a main housing 10 and a functional attachment 30, the functional attachment 30 is couplable to and decouplable from the main housing 10. The main housing 10 comprises a first coupling member 23 arranged in an upper wall 13 of the main housing 10. The functional attachment 30 comprises a second coupling member 33 arranged in a base member 31 of the functional attachment 30. The main housing 10 further comprises a U-shaped holder 20 for receiving and accommodating the base member 31. The handheld personal care device 1 is designed to accomplish that in a coupled condition of the main housing 10 and the functional attachment 30, the main housing 10 and the functional attachment 30 are mutually retained in an axial direction A exclusively by mutual engagement of the first and second coupling members 23, 33, and the base member 31 is enclosed and supported by two protruding wall portions 21, 22 of the U-shaped holder 20 in a sideward direction S without being connected or coupled to said two protruding wall portions 21, 22 in the axial direction A.

1. Handheld personal care device comprising a main housing and a functional attachment couplable to and decouplable from the main housing wherein the main housing comprises:
a front wall, a back wall, an upper wall and two oppositely arranged side walls that interconnect the front wall and the back wall;
a first coupling member arranged in said upper wall and having a first coupling axis; and
a U-shaped holder formed by said upper wall and by two oppositely arranged protruding wall portions that each form an extension of a respective one of said two side walls and extend beyond said upper wall;
wherein the functional attachment comprises:
a base member;
a functional personal care unit arranged on the base member; and
a second coupling member arranged in the base member and having a second coupling axis;
and wherein:
the first and second coupling members are mutually couplable by aligning the first and second coupling axes and moving the first and second coupling members towards each other along the aligned first and second coupling axes into mutual engagement;
the first and second coupling members are mutually decouplable by exerting a decoupling force greater than a predefined threshold force on one of the first and second coupling members in an axial direction parallel to the aligned first and second coupling axes and away from the other one of the first and second coupling members;
and wherein, in a coupled condition of the main housing and the functional attachment involving the base member being arranged within the U-shaped holder and the first and second coupling members being in mutual engagement:
the main housing and the functional attachment are mutually retained in the axial direction exclusively by the mutual engagement of the first and second coupling members; and
the base member of the functional attachment is enclosed and supported by the two protruding wall portions of the U-shaped holder in a sideward direction transverse to the aligned first and second coupling axes without being connected or coupled to said two protruding wall portions in the axial direction.

2. Handheld personal care device as claimed in claim 1, wherein, in the coupled condition of the main housing and the functional attachment, the base member of the functional attachment is supported by the upper wall of the main housing.

3. Handheld personal care device as claimed in claim 2, wherein:
the base member comprises a bottom wall;
the second coupling member is arranged in said bottom wall; and
in the coupled condition of the main housing and the functional attachment, said bottom wall is at least partially supported by the upper wall of the main housing.

4. Handheld personal care device as claimed in claim 3, wherein the upper wall of the main housing has an inclined orientation relative to an imaginary plane extending perpendicularly to the first coupling axis, and the bottom wall of the base member has an inclined orientation relative to an imaginary plane extending perpendicularly to the second coupling axis.

5. Handheld personal care device as claimed in claim 1, wherein the base member comprises a front wall, a back wall and two oppositely arranged side walls that interconnect the front wall and the back wall of the base member, and wherein, in the coupled condition of the main housing and the functional attachment, the side walls of the base member are each at least partially supported by a respective one of the two protruding wall portions of the U-shaped holder in the sideward direction.

6. Handheld personal care device as claimed in claim 1, wherein an average length of the two protruding wall portions of the U-shaped holder in the axial direction is at least 50%, and preferably at least 100% of an average distance between the two protruding wall portions in the sideward direction.

7. Handheld personal care device as claimed in claim 1, wherein an average length of the two protruding wall portions of the U-shaped holder in the axial direction is between 10% and 50% of a total length of the main housing in the axial direction.

8. Handheld personal care device as claimed in claim 1, wherein an average distance between the front wall and the back wall of the main housing, measured along the upper wall of the main housing in a direction perpendicular to both the axial direction and the sideward direction, is larger than an average distance between the two protruding wall portions of the U-shaped holder in the sideward direction.

9. Handheld personal care device as claimed in claim 1, wherein, seen in a cross-section perpendicular to the first coupling axis, an inner surface of each of the two protruding wall portions of the U-shaped holder is concave.

10. Handheld personal care device as claimed in claim 1, wherein the U-shaped holder and the base member are designed to enable the base member, in the coupled condition of the main housing and the functional attachment, to fit into the U-shaped holder only in a single predefined orientation relative to the U-shaped holder, whereby the functional attachment is couplable to the main housing only in a single predefined orientation relative to the main housing.

11. Handheld personal care device as claimed in claim 10, wherein an inner surface of each of the two protruding wall portions of the U-shaped holder has a shape that is non-symmetrical relative to a first imaginary plane comprising the first coupling axis and extending centrally between the front wall and the back wall of the main housing, and/or non-symmetrical relative to a second imaginary plane comprising the first coupling axis and extending centrally between the two protruding wall portions of the U-shaped holder.

12. Handheld personal care device as claimed in claim 1, wherein the base member and at least one of the two protruding wall portions of the U-shaped holder are provided with mutually engageable guiding members arranged parallel to the axial direction and configured and arranged to mutually engage during aligning of the first and second coupling axes and moving of the first and second coupling members towards each other along the aligned first and second coupling axes into mutual engagement.

13. Handheld personal care device as claimed in claim 1, wherein:
the main housing accommodates an electric motor and a driving member arranged to be driven by the motor;
the base member accommodates a driven member that is coupled to the driving member in the coupled condition of the main housing and the functional attachment;
the base member accommodates a mechanical transmission configured to convert motion of the driven member into a different motion of a movable portion of the functional personal care unit.

14. Handheld personal care device as claimed in claim 1, wherein the functional personal care unit is a shaving unit, a hair clipping unit, a beard trimming unit or a facial brushing unit.

15. Handheld personal care device as claimed in claim 1, wherein:
the handheld personal care device comprises a plurality of different functional attachments, each having a respective different functional personal care unit and each being alternatively couplable to the main housing; and
each of the plurality of different functional attachments comprises the base member, the second coupling member arranged in the base member, and the respective different functional personal care unit being arranged on top of the base member.
